(19) United States
(12) Patent Application Publication
(10) Pub. No.: US 2018/0086291 A1
(43) Pub. Date: Mar. 29, 2018

(54) DOOR CONTACT-PREVENTING SENSORS WITH DOOR BRAKING SYSTEM

(71) Applicant: Continental Automotive Systems, Inc., Auburn Hills, MI (US)

(72) Inventors: Jose Armando Valdivia Nuno, Zapopan (MX); Luis Ernesto Quiroz de la Mora, Tlaquepaque (MX); Jose Javier Ruiz Casillas, Tlajomulco de Zuniga (MX)

(21) Appl. No.: 15/279,555

(22) Filed: Sep. 29, 2016

(51) Int. Cl. B60R 16/023; B60J 5/04; G01S 15/08

(52) U.S. Cl. CPC B60R 16/023; G01S 15/08; B60J 5/04

(57) ABSTRACT

Contact damage to vehicle doors is prevented by detecting objects in the door's pathway and applying a braking force to the door before the door strikes the object.

### BACKGROUND

Automatic swinging door mechanisms are well known and some of them include sensors to detect an object nearby. For example, U.S. Pat. No. 6,678,999 entitled “Object Sensing System for Use with Automatic Swinging Door” purports to disclose an invention that detects whether an object is approaching a door and can be used to avoid collisions with the door.

While prior art methods can warn of the proximity of objects to a swinging door, they do not actively prevent a swinging door from hitting an object when the door is manually opened. A method and apparatus to prevent a door from contacting an object nearby would be an improvement over the prior art.

### BRIEF DESCRIPTION OF THE FIGURES

FIG. 1 depicts two motor vehicles side by side, one of them having a door opened;

FIG. 2 is a top view of the vehicles depicted in FIG. 1;

FIG. 3A depicts a driver's-side door of one of the vehicles shown in FIGS. 1 and 2 and the locations of a door brake, and proximity sensors;

FIG. 3B depicts the driver's side door attached to a vehicle and depicting the locations of the door brake, sensors and the locations of audible and visual alarms.

FIG. 4 is a block diagram of an apparatus for preventing contact damage to a vehicle door;

FIG. 5 depicts a vehicle door brake, position sensor and motion sensor attached to a door hinge pin; and

FIG. 6 depicts steps of a method for preventing contact damage to a vehicle door.

### DETAILED DESCRIPTION

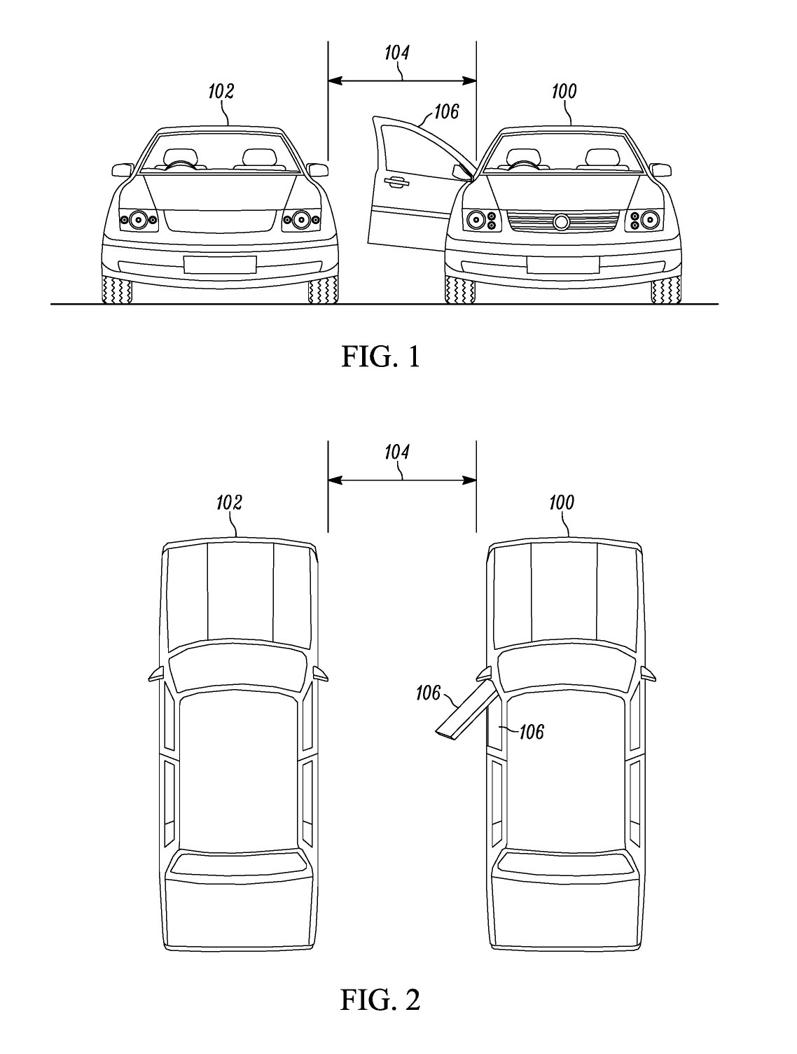

FIG. 1 depicts two parked motor vehicles 100 and 102. They are separated from each other by a distance 104, which just less than the length of a door 106 of one of the vehicles 100.

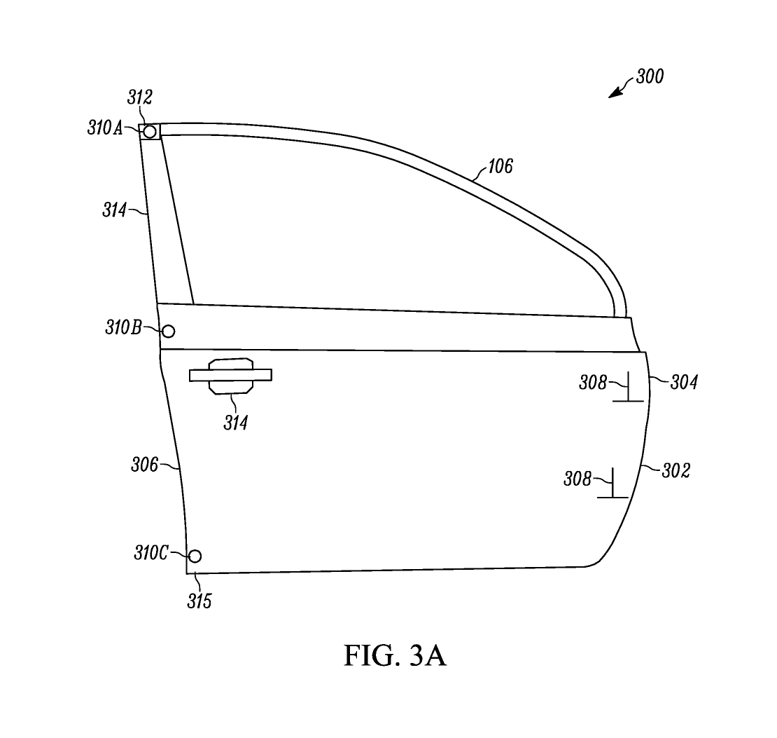

FIG. 2 is a top view of the two vehicles. The door 106 of one vehicle 100 is opened partway, allowing access to the vehicle 100 but held away from the adjacent vehicle 102. As described below, sensors and an active braking system attached to the door 106 prevent an inadvertent impact or contact of the door 106 to an adjacent vehicle 102.

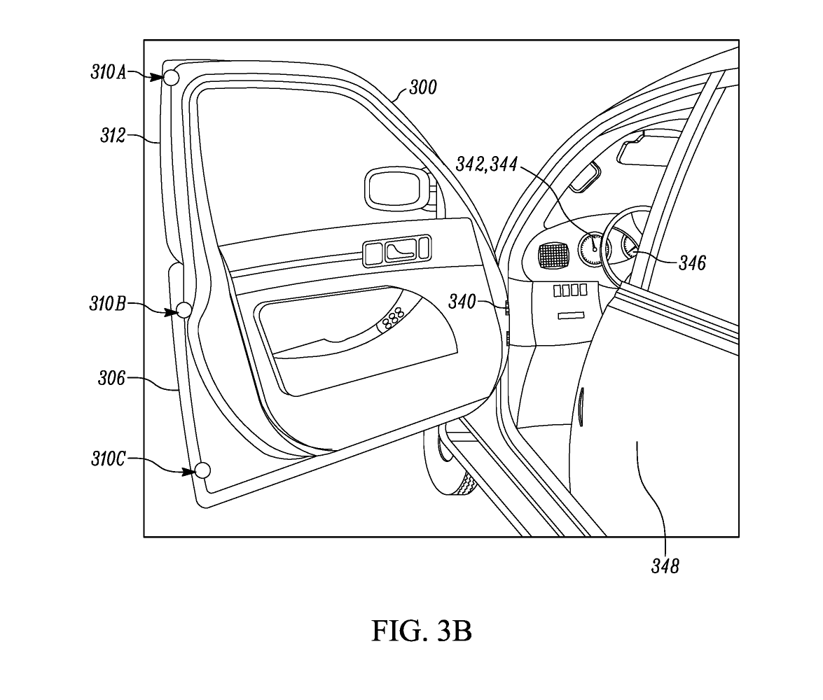

FIG. 3A depicts the inside surface of a vehicle door 300. The door 300 is mounted in a frame 302 having a hinge side 304 and an opposing latch side 306. Two hinges 308 on the hinge side 304 are provided with at least one electrically-operated brake, a rotation or motion sensor and a position sensor.

A plurality of object proximity sensors 310 are provided on the door's latch side 306. One proximity sensor 310A is located at the top corner 312 of the door's latch side 306. It is so located in order to detect objects that can damage the door pillar 314 if the door 300 is fully opened.

A second sensor 310B is located near a door handle 314 in order to detect other car bodies and other car doors, which could damage the edge of the door 300 is the door 300 is fully opened.

A third sensor 310C is located at the lower left corner 315 of the door's latch side 306 and positioned in order to detect sidewalk steps and street curbs, which are raised edges along a street or road to form part of a gutter.

In a preferred embodiment the proximity sensors 310 are embodied as ultrasonic range finders. Such sensors are well known and routinely used to measure even small distances.

FIG. 3B depicts an open vehicle door 300. It also shows the location of a door brake 340 attached to or adjacent a hinge pin. The door brake 340, which is electrically operated, is considered herein as being an apparatus to prevent contact damage to the vehicle door 300.

In addition to the door brake 340, FIG. 3B shows a visual warning indicator 342 and enunciator (an audible alarm) 344 located in the instrument panel 346 of a motor vehicle 348 and to which the door 300 is attached.

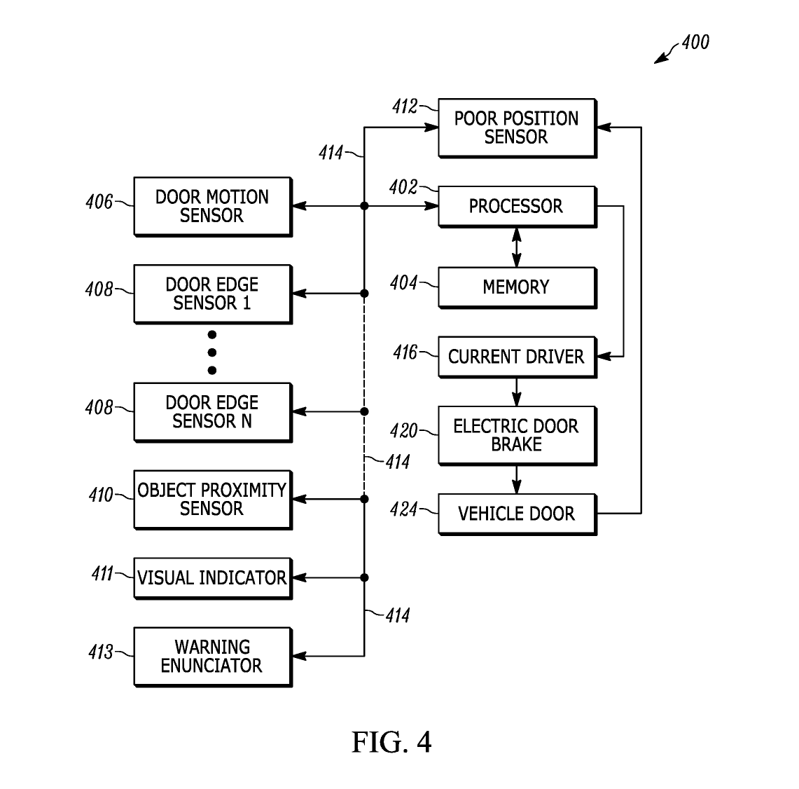

Referring now to FIG. 4, an apparatus 400 is shown, which can prevent contact damage to a vehicle door, as usually happens when the door opens too far, too fast and strikes an object in the door's path. The apparatus 400 comprises a processor 402 operatively coupled to a non-transitory memory 404 through a conventional address/data/control bus 403. The processor 402 executes instructions stored in the memory 404, which when executed, cause the processor to perform various read and write operations, from and to, peripheral devices coupled to the processor 402 through a peripheral bus 414. Stated another way, the instructions in the memory 404 cause the processor 402 control the various peripheral devices connected to the processor 402

One type of peripheral device under the control of the processor 402 is a door motion sensor 406. The door motion sensor 406 is preferably embodied as an accelerometer coupled to the door 106 and which detects movement of the door in a horizontal plane.

Door edge sensors or proximity sensors 408A-408C, also connected to the processor 402 and considered to be “peripherals,” detect objects near the door pillar, door edge and door bottom. Such objects include but are not limited to adjacent cars, and sidewalks and curb. The sensors detect objects using ultrasonic waves.

As used herein, the door edge sensors are considered to be object proximity sensors because they detect the distance between at least a portion of the door edge and adjacent objects, i.e., they detect whether an object is proximate to or in the vicinity of the vehicle door.

A door position sensor 412, also coupled to the door itself, determines whether the door is in a closed or latched position or starting to move to an open position.

Using the sensors described above, and executing instructions stored in the memory device 404, the processor 402 determines when a door is open or starting to open, whether the door is moving, how fast it is moving, the direction it is moving and what objects are in the door's path. Program instructions stored in the memory device 404 cause the processor 402 to determine if an object is detected by one of the sensors 408, determine the distance to the closest object, measure the door speed and, using the door speed, calculate the time to impact of the door with the object.

By knowing the distance to an object, the door's speed, and time to impact, instructions stored in the memory device 404 cause the processor 402 to calculate the deceleration required to stop the door before it strikes the closest object. Stated another way, the instructions in the memory device cause the processor to determine a required deceleration and thus a decelerating force that is required to stop the door using an active electric brake mechanism 420 coupled to the door hinges. Other instructions in the memory device 404 also cause the processor 402 to activate the electric brake mechanism 420 in order to prevent a closed door from opening when an object is detected and determined to be in the path of a portion of the door.

When an object is determined or detected as being within striking distance of the vehicle's door, program instructions stored in the memory device 404 cause the processor 402 to send signals to warning indicators, 411, 413. One such indicator is a visual indicator 411, e.g., a warning light on the vehicle's instrument panel. A warning sound from a warning enunciator 413, such as a buzzer or chime, can also be provided with or instead of a visual warning.

Still referring to FIG. 4, the processor is coupled to a current driver 416, which provides electric current 418 to an electrically operated door brake 420.

The door brake 420 applies a motion-inhibiting resistance or friction force to the door 424, through the door hinge of the vehicle door 424 causing the door 424 to be essentially locked, or be slow to open or held closed.

In an alternate embodiment, when a door is held closed, program instructions and sensors allow the processor 402 to detect when an occupant of the vehicle wants to override the door brake. A brake override is preferably embodied as pulling or actuating a handle or lever normally used to open the door from inside the vehicle. When such an action is detected, a door that is held closed is allowed to open.

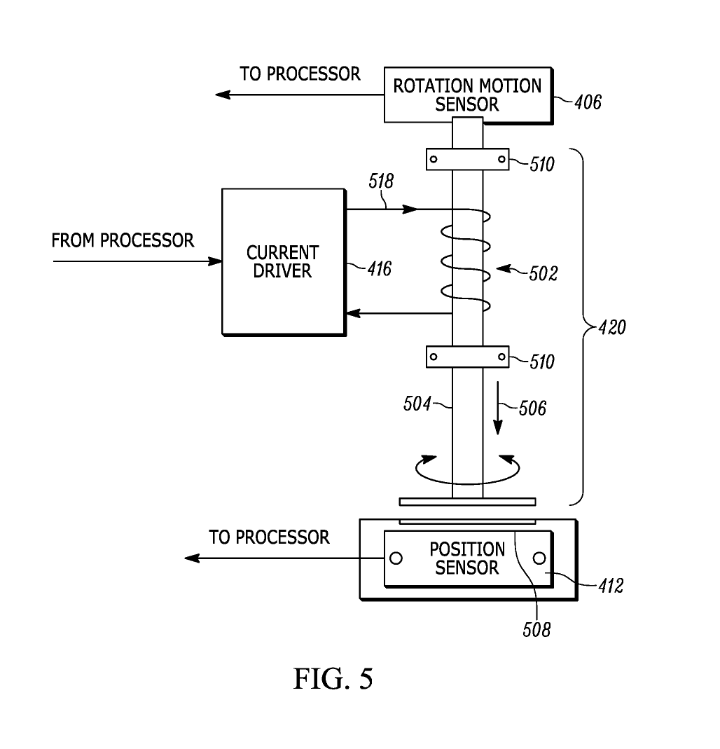

FIG. 5 depicts the current driver 416, the electric door brake mechanism 420, a motion or rotation sensor 406 and the door position sensor 412. The electric door brake 420 is embodied as a coil 502 and armature 504 which is pushed downwardly 506 against a friction wheel 508 coupled to the door frame hinge 510. The door frame hinge is mounted to the vehicle chassis, not shown. An electric current 518 applied to the coil 502 thus provides a frictional braking force to the door. The magnitude of the braking force is proportional to the current 518 provided to the coil 502 by the driver 416.

The driver 416 is of course responsive to commands sent to it by the processor 402. Stated another way, instructions stored in the memory device 404 cause the processor 402 to restrain, brake or decelerate or completely stop the door by the application of current 518, the magnitude of which is calculated to be an amount required to either restrain or stop the door from opening or decelerate or brake the door before it strikes a nearby object.

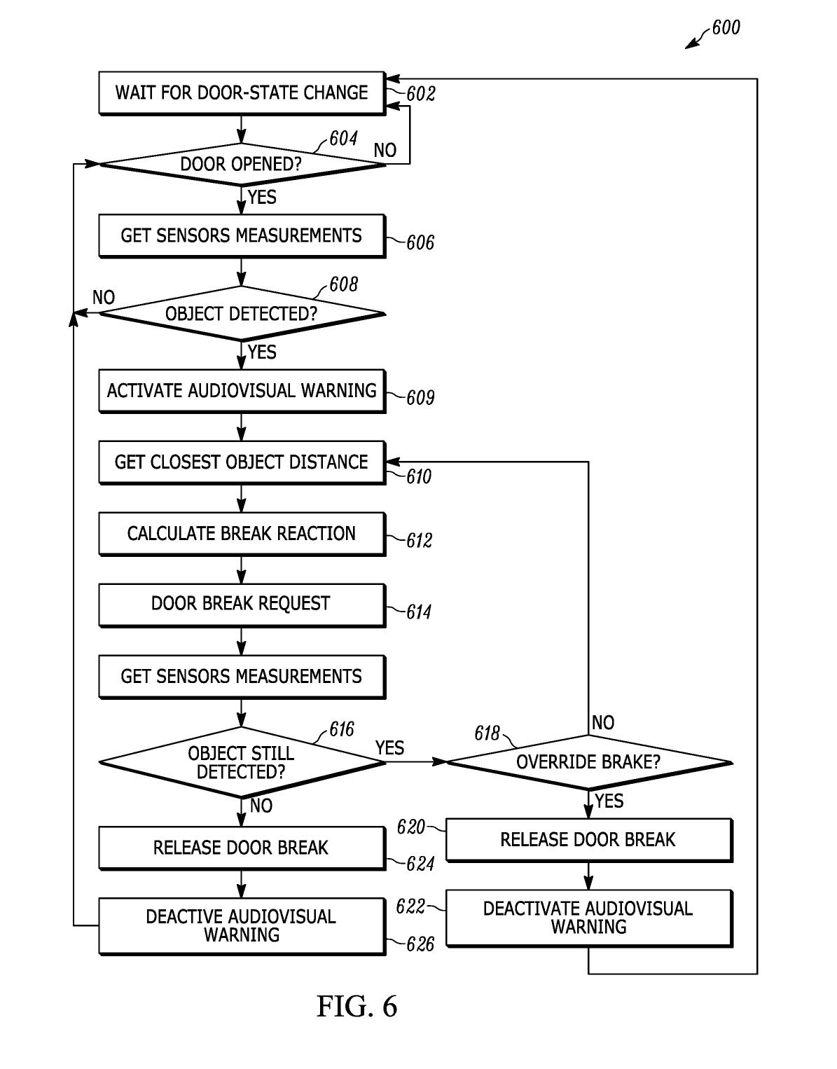

FIG. 6 depicts steps of a method for preventing contact damage to a vehicle door. At a first step 602, the method waits for a door-open signal from the door position sensor 412, i.e., a door-state change signal. After the determination that the door is open at step 604, the method obtains measurements at step 606 from the proximity sensors 408A-408C. If an object is detected at step 608, the method proceeds to step 609, whereat one or more visual and audio alarms are provided to the vehicle occupants. If no object is detected at step 608, the method returns to step 604 and continually monitors the proximity sensors, unless the door is not opened, in which case the method returns to step 602 and waits until a door-state change signal is received.

If at step 608 a nearby object is detected by one of the proximity sensors, audio and visual warnings are provided to the occupant at step 609.

At step 610, a determination is made as to the distance between the door edge and closest object. If the door is determined to be too close, i.e., the door will strike the object if the door is opened. Electric current is thus provided to the door brake at step 612, in order to hold the door so that it cannot be opened, i.e., a “brake reaction” is calculated and the current required to provide such a force is applied at step 614.

At step 615, sensor measurements are “taken” again to determine, at step 616, whether an object is still in the door's path. If an object is still in the door's path, a test is made at step 618 as to whether an vehicle occupant wants to “override” the electric brake and open the door.

If the occupant chooses not to override the door brake, the method continues to loop through steps 610-616 until the object, or vehicle, move out of the door's path or until the vehicle occupant chooses to override the door brake at step 618. If so, current to the brake is removed or stopped at step 620 so that the door can be opened. The previously-activated warnings are deactivated at step 622.

Returning to step 616, when an object leaves or is no longer present, the door brake is released at step 624 allowing the door to be fully opened or closed. The previously-activate warning is deactivated at step 626.

In an alternate embodiment, different instructions in the memory device 404 cause the processor 402 to determine a distance to a closest object, before a door starts to open. Instructions cause the processor 402 to allow the door to open but apply a braking force to the door by supplying current to the electric brake just before a door edge or surface will strike the object. The alternate embodiment thus includes program instructions by which the processor calculates the time and force required to stop an opening door prior to its impacting a nearby object.

Those of ordinary skill in the art will recognize that the foregoing description is for purposes of illustration only. The true scope of the invention is set forth in the following claims.

What is claimed is:

1. A method of preventing contact damage to a vehicle door, the method comprising:
detecting when a vehicle door is moving to open;
detecting an object within a predetermined distance from the moving vehicle door;
determining a distance to the object detected as being within the predetermined distance;
when an object is detected as being within the predetermined distance, providing electric current to an electric brake, which is coupled to the vehicle door and configured to hold the door closed responsive to the electric current.

2. The method of claim 1, wherein the vehicle door moves freely and without a braking force applied to it when no object is detected as being within the predetermined distance.

3. The method of claim 1, wherein the vehicle door has a hinge side and an opposing latch side, wherein the step of detecting an object within a predetermined distance from the moving vehicle door comprises:
obtaining object proximity-signals from at least one sensor coupled to the latch side of the vehicle door.

4. The method of claim 1, wherein obtaining object proximity-signals from at least one sensor coupled to the latch side of the vehicle door comprises:
obtaining distance information from an ultrasonic sensor coupled to the latch side of the vehicle door.

5. The method of claim 1, wherein determining a braking force that will be required to stop the moving vehicle door prior to striking the detected object comprises:
determining an electric current to be applied to a magnet coil, which when energized, applies a braking force corresponding to the required braking force.

6. A method of preventing contact damage to a vehicle door, the method comprising:
detecting when a vehicle door is moving to open;
detecting an object within a predetermined distance from the moving vehicle door;
determining a distance to the object detected as being within the predetermined distance;
calculating a time required to brake the moving vehicle door;
determining a braking force that will be required to stop the moving vehicle door prior to striking the detected object and determining a brake application time required to prevent the moving vehicle door from striking the detected object, using the determined braking force; and
applying the braking force to the moving vehicle door at the determined brake application time.

7. The method of claim 6, wherein the vehicle door moves freely and without a braking force applied to it prior, prior to the determined brake application time.

8. The method of claim 6, wherein the vehicle door has a hinge side and an opposing latch side, wherein the step of detecting an object within a predetermined distance from the moving vehicle door comprises:
obtaining object proximity-signals from at least one sensor coupled to the latch side of the vehicle door.

9. The method of claim 6, further comprising:
obtaining object proximity-signals from at least one sensor coupled to an edge of vehicle door, the edge being located at the latch side of the vehicle door.

10. The method of claim 6, wherein obtaining object proximity-signals from at least one sensor coupled to the latch side of the vehicle door comprises:
obtaining distance information from an ultrasonic sensor coupled to the latch side of the vehicle door.

11. The method of claim 6, wherein determining a braking force that will be required to stop the moving vehicle door prior to striking the detected object comprises:
determining an electric current to be applied to a magnet coil, which when energized, applies a braking force corresponding to the electric current.

12. The method of claim 6, wherein determining a brake application time required to prevent the moving vehicle door from striking the detected object comprises:
calculating a time required to decelerate the moving vehicle door responsive to an applied braking force.

13. An apparatus for preventing contact damage to a vehicle door, the apparatus comprising:
a first sensor coupled to a vehicle door, the sensor being configured and arranged to determine when the vehicle door is moving open;
a second sensor coupled to the vehicle door, the second sensor being configured to detect a distance to an object that is within a predetermined distance from the moving vehicle door;
an electrically actuated door brake;
a processor coupled to the first and second sensors and coupled to the door brake;
a memory coupled to the processor and storing executable program instructions, which when executed cause the processor to:
obtain a first signal from the first sensor, which indicates that the vehicle door is moving open;
obtain a second signal from the second sensor, the second signal indicating to the processor, a distance between the second sensor and an object that is within a predetermined distance from the moving vehicle door;
calculate a braking force required to prevent the vehicle door from opening; and
provide an electrical signal to the electrically actuated door brake that corresponds to the calculated braking force.

14. The apparatus of claim 13, further comprising a current source operatively coupled to and under the control of the processor, the current source being coupled to the electrically actuated door brake and providing electric current thereto, wherein the program instructions cause the processor to calculate an electric current to be provided to the door brake.

15. The apparatus of claim 13, wherein the vehicle door has a hinge side and an opposing latch side, wherein the second sensor is coupled to an edge of the vehicle door located on the latch side of the door.

16. The apparatus of claim 13, wherein the electrically actuated door brake is operatively coupled to the hinge side of the door.
